(19) United States
(12) Patent Application Publication
(10) Pub. No.: US 2009/0199260 A1
(43) Pub. Date: Aug. 6, 2009

(54) Coordinated Output of Pictures of a Video Program from a Decoder and an Encoder

(76) Inventors: Arturo A. Rodriguez, Norcross, GA (US); Ajith N. Nair, Lawrenceville, GA (US); Douglas F. Woodhead, Suwanee, GA (US)

Correspondence Address: MERCHANT & GOULD;SCIENTIFIC ATLANTA, A CISCO COMPANY, P.O. BOX 2903, MINNEAPOLIS, MN, 55402-0903, US

(21) Appl. No.: 12/390,451

(22) Filed: Feb. 21, 2009

Related U.S. Application Data
(63) Continuation of application No. 11/831,928, filed on Jul. 31, 2007.

(51) Int. Cl. H04N 7/16

(52) U.S. Cl. 725/151

(57) ABSTRACT

Video processing systems and methods are disclosed. One system embodiment, among others, includes a video compression engine configured to provide reconstructed pictures corresponding to a real-time presentation of a video program and a compressed version of the real-time presentation, a display buffer of the video compression engine, the display buffer configured to store the reconstructed pictures, and a persistent storage device, wherein the video compression engine is further configured to store the compressed version of the real-time presentation to the persistent storage device while simultaneously providing the real-time presentation of the video program.

### CROSS REFERENCE TO RELATED APPLICATION

This application is a continuation of U.S. utility application Ser. No. 11/831,928, filed Jul. 31, 2007, which is incorporated herein by reference in its entirety.

### FIELD OF THE INVENTION

The present disclosure is generally related to video, and more particularly related to video compression and decompression.

### BACKGROUND OF THE INVENTION

Subscriber television systems typically use television set-top terminals (STTs) to receive signals comprising video programs and other information over a media such as air or cable. In some implementations, the STT may digitize the signals and route the digitized signals directly to a video output port for subsequent display on a television set. However, in many implementations, the STT processes the received signals for enabling time-shifted presentations of the video programs. For example, the STT may digitize a received video program and compress the digitized video program according to the syntax and semantics of a video coding specification, such as one produced by a standard body or MPEG (Motion Pictures Experts Group). The compressed video program is routed to a storage device, for example a hard disk drive (HDD), which is coupled to or integrated with the STT. From the HDD, the compressed video program is decompressed and then presented on a television via a video output port. This latter implementation enables viewer interaction with the video program presentation. For instance, the viewer can pause the presentation and then return to normal playback without missing portions of the video program. However, the need to maintain consistent picture quality between real-time and time-shifted instances of the video program presentation imposes certain real-time processing operations to be performed on the video program, irrespective of whether a time-shifted operation has been invoked by the viewer.

One problem presented by the time-shift implementation is that of considerable STT resource consumption, such as memory bus bandwidth and HDD access, which hinders the capability to process simultaneously other video programs or their presentations in the STT. Video processing operations, such as compression and decompression operations, are real-time operations that require dedicated resources. Therefore, there exists a need for systems and methods for addressing these and/or other problems associated with the processing and presentations of video programs, as well as other information, provided within a subscriber television system.

### BRIEF DESCRIPTION OF THE DRAWINGS

Embodiments of the disclosed systems and methods can be understood with reference to the following drawings. The components in the drawings are not necessarily drawn to scale, emphasis instead being placed upon clearly illustrating the principles of the present disclosure. In the drawings, like reference numerals designate corresponding parts throughout the several views.

FIG. 1 is a high-level block diagram depicting a non-limiting example of a subscriber television system.

FIG. 2 is a block diagram of a set-top terminal (STT) in accordance with one embodiment of the disclosure.

FIG. 3 is a flow diagram that illustrates video processing in a video processing system in accordance with one embodiment of the disclosure.

FIG. 4 is a flow diagram that illustrates video processing in a video processing system in accordance with another embodiment of the disclosure.

FIG. 5 is a functional flow diagram that illustrates portions of video data in compression engine memory in accordance with the video processing illustrated in FIG. 4.

FIG. 6 is a functional flow diagram that illustrates compression engine copying of portions of video data in compression engine memory in accordance with the video processing illustrated in FIG. 4.

FIG. 7 is a functional flow diagram that illustrates compression engine copying of video data in compression engine memory in accordance with the video processing illustrated in FIG. 4.

FIG. 8 is a functional flow diagram that illustrates decompression engine access of video data in compression engine memory using metadata or auxiliary data as an index to specified locations of the video data in accordance with the video processing illustrated in FIG. 4.

### DETAILED DESCRIPTION OF THE PREFERRED EMBODIMENTS

Preferred embodiments of a video processing system and method (herein, collectively video processing system) can be understood in the context of a set-top terminal (STT) in a subscriber television system.

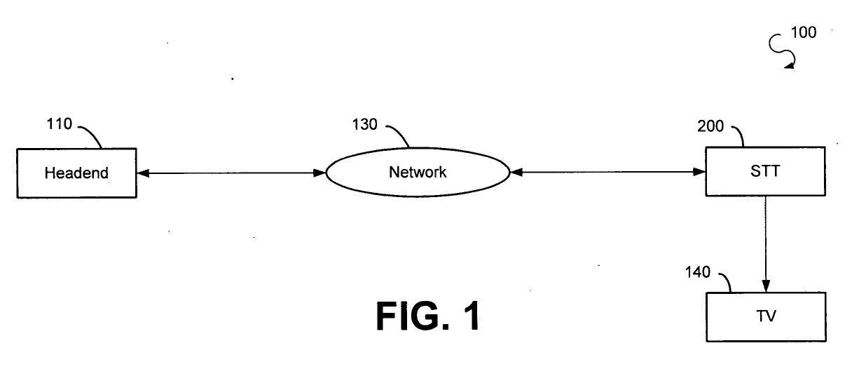

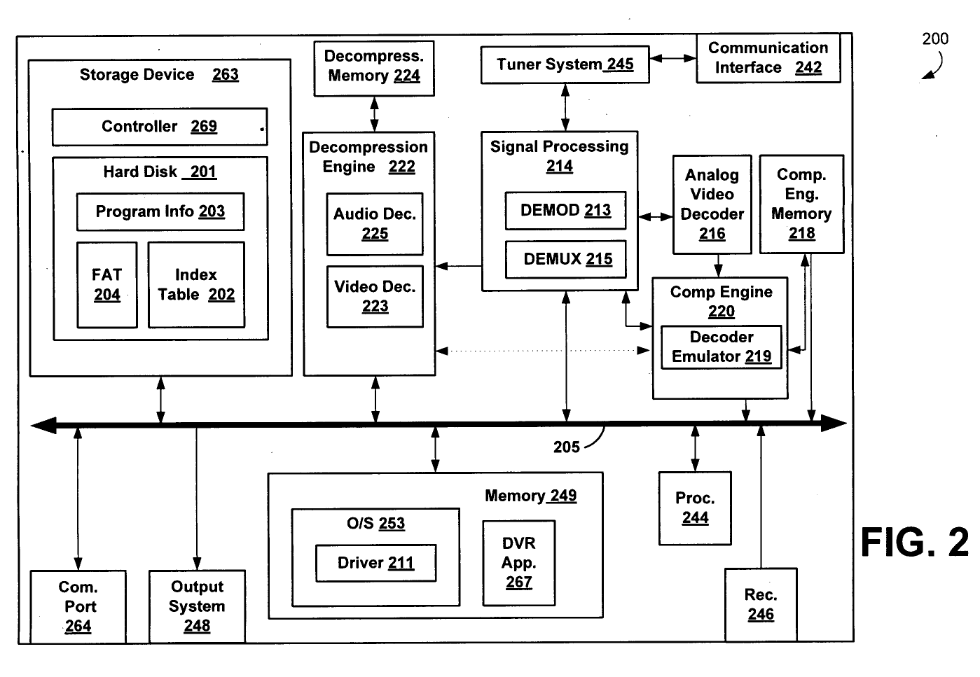

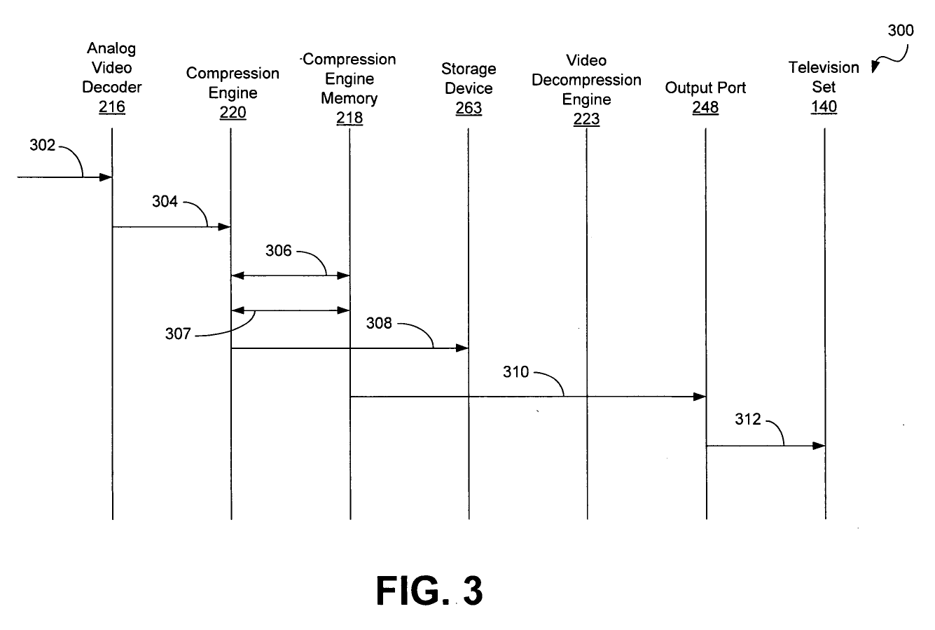

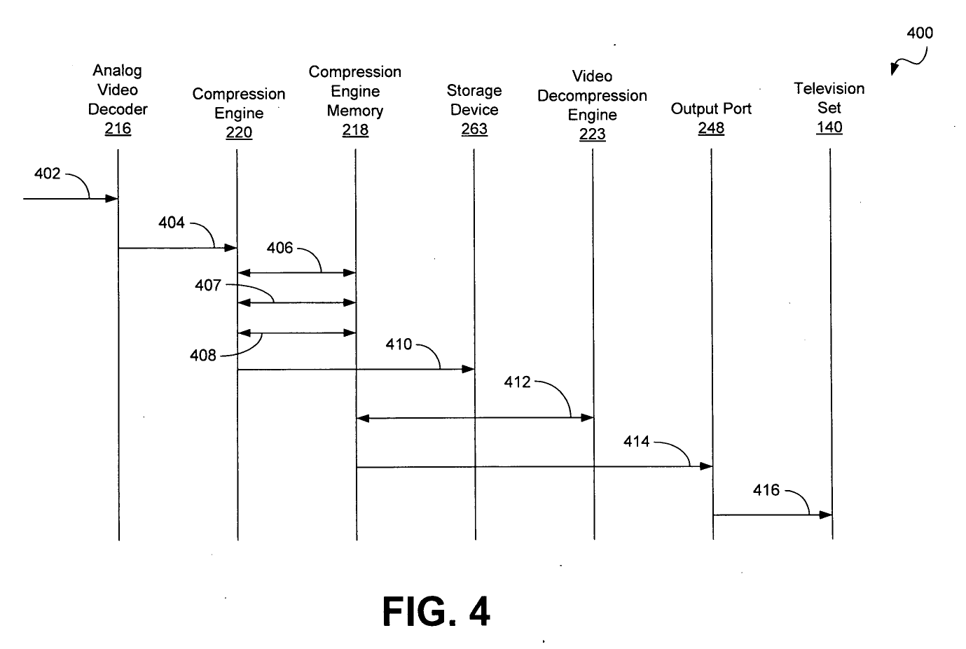

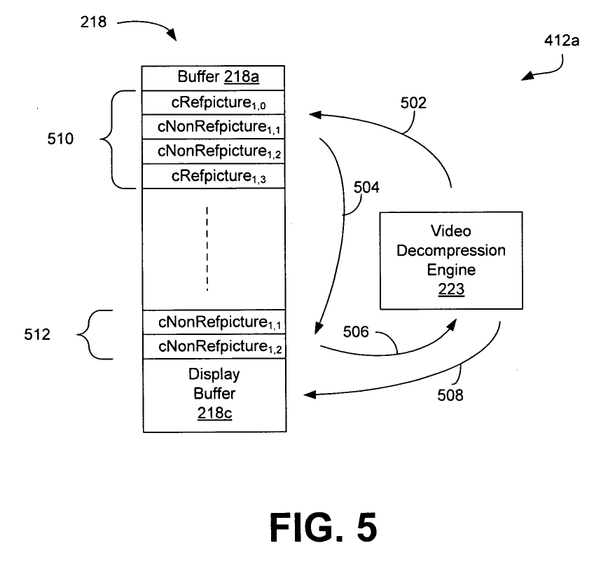

The accompanying drawings include FIGS. 1-8. FIG. 1 provides an example, among others, of a subscriber television system in which a video processing system may be implemented; FIG. 2 provides an example, among others, of a set-top terminal (STT) that may comprise a video processing system. FIG. 3 illustrates video processing according to one embodiment of a video processing system; FIG. 4 shows video processing according to another embodiment of a video processing system; and FIGS. 5-8 are various diagrams that illustrate various methods employed by the video processing system in performing the video processing illustrated in FIG. 4. Note, however, that a video processing system may be embodied in many different forms and should not be construed as limited to the embodiments set forth herein. Furthermore, all examples given herein are intended to be non-limiting, among others, and are provided to assist in understanding the disclosure.

FIG. 1 is a block diagram depicting a non-limiting example of a subscriber television system 100. Note that the subscriber television system 100 shown in FIG. 1 is merely illustrative and should not be construed as implying any limitations upon the scope of the preferred embodiments. In this example, the subscriber television system 100 includes a headend 110 and a STT 200 that are coupled via a network 130. The STT 200 is typically situated at a user's residence or place of business and may be a stand-alone unit or integrated into another device such as, for example, a television set 140.

The headend 110 and the STT 200 cooperate to provide a user with television functionality including, for example, video programs such as broadcast television programs or video-on-demand (VOD) presentations, an interactive program guide (IPG), and/or Web content. The headend 110 may include one or more server devices (not shown) for providing video, audio, and textual data to client devices such as the STT 200. The headend 110 may further provide authorization signals or messages that enable the STT 200 to perform corresponding authorized functionality.

The STT 200 receives signals corresponding to video programs, each possibly carrying video, audio and/or other data, including, for example, video as an MPEG-2 video stream or an H.264 video stream, among others, from the headend 110 through the network 130 and provides any reverse information to the headend 110 through the network 130. The network 130 may comprise any suitable mechanisms and/or media for communicating television services data including, for example, a cable television network or a satellite television network, among others.

FIG. 2 is a block diagram illustrating selected components of a STT 200 in accordance with one embodiment of the disclosure. Note that the STT 200 shown in FIG. 2 is merely illustrative and should not be construed as implying any limitations upon the scope of the preferred embodiments of the disclosure. For example, in some embodiments, the STT 200 may have fewer, additional, and/or different components than those illustrated in FIG. 2.

The STT 200 preferably includes at least one processor 244 for controlling operations of the STT 200, an output system 248 for outputting one or more video programs for presentation at the television set 140 (FIG. 1), and a tuner system 245 for tuning to a particular television channel or frequency and for sending and receiving various types of data to/from the headend 110 (FIG. 1) via communication interface 242. The STT 200 may, in some embodiments, include multiple tuners for receiving downloaded (or transmitted) video programs or data. The tuner system 245 enables the STT 200 to tune to downstream media and data transmissions, thereby allowing a user to receive digital or analog signals of respective video programs. The tuner system 245 includes, in one implementation, an out-of-band tuner for bidirectional quadrature phase shift keying (QPSK) data communication and a quadrature amplitude modulation (QAM) tuner (in band) for receiving television signals. Additionally, a receiver 246 receives externally-generated user inputs or commands from an input device such as, for example, a remote control device.

In one implementation, video streams are received in the STT 200 via communication interface 242 (e.g., a coaxial cable interface) and stored in a temporary memory cache. The temporary memory cache may be a designated section of memory 249 or another memory device connected directly to the communication interface 242. Such a memory cache may be implemented and managed to enable data transfers to/from a persistent storage device 263 (e.g., hard disk drive, optical disk drive, etc.).

The STT 200 may include one or more wireless or wired interfaces, also called communication ports 264, for receiving and/or transmitting data to other devices. For instance, the STT 200 may feature USB (Universal Serial Bus), Ethernet, IEEE-1394, serial, and/or parallel ports, etc. The STT 200 may also include an analog video input port for receiving analog video signals.

Video programs and their respective video streams and/or signals may be received by the STT 200 from different sources. For example, an input video stream or signal received by the STT 200 may comprise any of the following, among others:

1—Broadcast analog video signals that are received from the headend 110 (FIG. 1) via the network communication interface 242—Analog video signals that are received from a consumer electronics device (e.g., an analog video camcorder) via analog an audio and video connector such as, for example, S-Video, input, composite video input, or component video.

2—A broadcast or on-demand digital video stream that is received via the network communication interface 242 from the headend 110 or a device elsewhere in network 130. For instance, the video stream associated with a video program may be in accordance with the syntax and semantics of a video coding specification, such as the MPEG-2 video standard or the ITU H.264 standard, and further be in a standard definition (SD) format or a high definition (HD) format.

3—A digital video stream that is received from a digital consumer electronic device (such as a personal computer or a digital video camcorder) via a digital video interface or a home network interface such as USB, IEEE-1394, HDMI, or Ethernet.

4—A digital video stream that is received from an externally connected storage device (e.g., a DVD player) via a digital video interface or a communication interface such as IDE, SCSI, USB, IEEE-1394 or Ethernet.

The STT 200 includes a signal processing system 214, which comprises a demodulating system 213 and a transport demultiplexing and parsing system 215 (herein referred to as demultiplexing system 215) for processing video programs, broadcast media content, and/or data. One or more of the components of the signal processing system 214 can be implemented with software, a combination of software and hardware, or hardware (e.g., an application specific integrated circuit (ASIC)).

The demodulating system 213 comprises functionality for demodulating transmission signals. For instance, the demodulating system 213 can demodulate a digital transmission signal in a carrier frequency that was modulated as a QAM-modulated signal. When possessing the capabilities and tuned to a carrier frequency corresponding to an analog TV signal, the demultiplexing system 215 may be bypassed and the demodulated analog TV signal that is output by demodulating system 213 may instead be routed to an analog video decoder 216.

The analog video decoder 216 converts the analog TV signal into a sequence of digitized pictures along with their respective digitized audio. The digitized pictures (and respective audio) are output by the analog video decoder 216 in sequential display order and presented as digitized pictures at the input of a compression engine 220 (herein, also video compression engine). The compression engine 220 further comprises a decoder emulator 219, as explained below. Simultaneously, the digitized pictures and respective audio may be also output to the television set 140 via the output system 248. For instance, the digitized pictures and respective audio output by the analog video decoder 216 (in sequential display order) may be presented for formatting by some output formatting stage in STT 200, such as a display pipeline (not shown) between common bus 205 and output system 248 to prepare the signal in a manner suitable for presentation to a display, and then output to the output system 248 (also referred to as a video output port). In some embodiments, formatting for display may be implemented at the output system 248.

The compression engine 220 converts the digital video and/or audio data into respective compressed video and audio streams according to a specified compression format. The digital video and/or audio may be received at the compression engine 220 via, among other mechanisms, the analog decoder 216 (e.g., from a video signal received via communication interface 242), or as a sequence of pictures in display order that are decompressed and reconstructed by the video decompression engine 223 when decompressing a video stream as part of a transcoding operation. The transcoding operation may be as set forth in co-pending and commonly owned U.S. utility application entitled “Resource-Adaptive Management of Video Storage,” having Ser. No. 10/663,037, herein incorporated by reference in its entirety. The format of the compressed audio and/or video streams may be produced in accordance with respective audio and video coding specifications, such as compression standards, as well as reconstructed by decoder emulator 219 in compression engine memory 218.

Examples, among others, of currently known compression standards can be found in the following publications:

(1) ISO/IEC International Standard IS 11172-2, “Information technology—Coding of moving pictures and associated audio for digital storage media at up to about 1.5 Mbits/s—Part 2: video,” 1993;

(2) ITU-T Recommendation H-262 (1996): “Generic coding of moving pictures and associated audio information: Video,” (ISO/IEC 13818-2);

(3) ITU-T Recommendation H.261 (1993): “Video codec for audiovisual services at px64 kbits/s”; and

(4) Draft ITU-T Recommendation H.263 (1995): “Video codec for low bitrate communications.”

(5) Draft ITU-T Recommendation H.264 (2003) (ISO/IEC 14496-10).

In one embodiment, the compression engine 220 is configured to receive and compress digitized picture sequences, and output compressed video streams with associated audio in parallel with real-time processing. Herein, real-time processing refers to processing audio and video data and/or streams at the rate in which they would ordinarily be processed for output to a television or display device. However, it should be noted that real-time processing does not necessarily imply outputting of audio or video.

The compression engine 220 multiplexes the packetized video compressed stream and other associated streams associated with a video program, such as audio, into a transport stream, such as, for example, an MPEG-2 transport stream. Furthermore, the compression engine 220 can be configured to compress audio and video corresponding to more than one video program in parallel (e.g., two tuned analog TV signals when STT 200 has multiple tuners, a tuned TV signal and a decompressed program, etc.), and to multiplex the respective audio and video compressed streams into a single transport stream. The output of the compression engine 220 may be provided to the signal processing system 214. Note that video and audio data may be temporarily stored in memory 249 by one module prior to being retrieved and processed by another module. Alternatively, it may be stored in compression memory 218.

The demultiplexing system 215 can include MPEG-2 transport demultiplexing. When tuned to carrier frequencies carrying a digital transmission signal, the demultiplexing system 215 enables the extraction of packets of data corresponding to the desired video streams. Therefore, the demultiplexing system 215 can preclude further processing of data packets corresponding to undesired video streams.

The components of the signal processing system 214 are preferably capable of QAM demodulation, forward error correction, demultiplexing of MPEG-2 transport streams, and parsing of packetized elementary streams. The signal processing system 214 is also capable of communicating with the processor 244 via interrupt and messaging capabilities of the STT 200. Compressed video and audio streams that are output by the signal processing system 214 can be stored in a storage device 263, or can be provided to the decompression engine 222, where they can be reconstructed by the video decompression engine 223 and audio decompression engine 225 prior to being output to the television set 140 (FIG. 1). In one embodiment, compressed video and audio streams that are output by the signal processing system 214 are stored in the storage device 263 and simultaneously provided to the decompression engine 222, where they are reconstructed by the video decompression engine 223 and audio decompression engine 225 prior to being output to the television set 140.

One having ordinary skill in the art should understand that the signal processing system 214 may include other components not shown, including memory, decryptors, samplers, digitizers (e.g., analog-to-digital converters), and multiplexers, among others. Furthermore, components of the signal processing system 214 can be spatially located in different areas of the STT 200, among other locations.

The demultiplexing system 215 parses (i.e., reads and interprets) compressed streams to interpret sequence headers and picture headers, and deposits a transport stream carrying compressed streams into memory 249. The processor 244 interprets the data output by the signal processing system 214 and generates ancillary data in the form of a table or data structure comprising the relative or absolute location of the beginning of certain pictures in the compressed video stream. In one embodiment, such ancillary data is used to identify the beginning of segments comprising consecutive pictures in a compressed stream, and to facilitate access to one or more of such segments. In some embodiments, the processor 244, the compression engine 220, or a combination of both may generate ancillary data or meta data for use by other components of the STT 200, such as the video decompression engine 223. For example, such ancillary data or meta data may be used by the video decompression engine 223 to locate the start of compressed, non-reference pictures in a compressed video stream buffer (herein, also a video stream buffer) in the compression engine memory 218, as described further below. Also, the ancillary data may, for example, facilitate a plurality of playback modes starting from a correct location in a video stream. The plurality of playback modes, also known as trick modes or random access operations, may include, for example, pause, fast forward, slow forward play, normal speed play, fast reverse play, slow reverse play, and rewind.

In one embodiment, digitized pictures of a received analog video program are provided to compression engine 220. In another embodiment, the video program is received by STT 200 as a transport stream that includes a compressed video stream (herein, also video stream). Sequential portions of the video stream are stored in a section of decompression engine memory 224 designated as an input video stream buffer (not shown). Each portion of the received video stream may correspond to a compressed picture. Decompression engine 222 accesses compressed pictures from the input video stream buffer in decompression engine memory 224. Decompression engine 222 decompresses and reconstructs pictures of the compressed video stream and provides them to the compression engine 220 as digitized pictures (e.g., uncompressed).

The compression engine 220 compresses the digitized uncompressed pictures, producing sequential portions of a video stream that are stored in a section of compression engine memory 218 designated as an output video stream buffer. The output video stream buffer is implemented as a circular buffer. Thus, a subsequent produced portion of the video stream may be stored in the output video stream buffer where a prior produced portion resided. Each portion of the produced video stream may correspond to a compressed picture. Compression engine 220, controller 269 of persistent storage device 263, and processor 244 cooperate to transfer progressive sequential portions of the video stream in compression engine memory 218 to persistent storage device 263, where the video stream is stored for later use, for instance, subsequent to a pause command. Decoding or decompression functionality of the compression engine 220 counters the effect of compression to emulate the steps of a video decoder, such as video decompression engine 223. The decoding functionality, herein also referred to as a decoder emulator 219, produces reconstructed pictures corresponding to the decompressed version of respective pictures in the video stream being produced by compression engine 220. Both the compressed pictures and reconstructed pictures produced are stored in compression engine memory 218 as the sequence of digitized pictures is processed by compression engine 220. As compressed pictures of the compressed video stream are being produced and stored in compression engine memory 218, decoder emulator 219 produces reconstructed pictures that are also stored in compression engine memory 218. As sequential portions of the compressed video stream are transferred to persistent storage device 263, a subsequent portion of the compressed video stream is stored in compression engine memory 218.

A reconstructed picture generally refers to a picture that is equivalent to one that has been compressed and then decompressed. A reconstructed picture produced by decoder emulator 219 and stored in compression engine memory 218 is equivalent to the decompressed version of a compressed picture that a video decoder, such as decompression engine 222, would produce when it decompresses the same compressed picture. In one embodiment, decoder emulator 219 is configured to reconstruct pictures that are reference pictures (e.g., I and P pictures in MPEG-2 video). Such reference pictures, or portions thereof, may be used by the compression engine 220 to perform motion estimation in the process of compressing other pictures. Reference pictures, or portions thereof, are used by the decoder emulator 219 to implement motion compensation in the reconstruction of other pictures in compression engine memory 218.

Reconstructed pictures produced by decoder emulator 219 are stored in a section of compression engine memory 218 designated to store one or more reconstructed pictures. This designated section of compression engine memory 218 may be demarcated into framestores, each of a sufficient amount of memory to store a single reconstructed picture. A reconstructed picture may be stored in compression engine memory 218 where a prior reconstructed picture resided, such as when the prior reconstructed picture is no longer required by compression engine 220. In one embodiment, the reconstructed pictures in compression engine memory 218 are output for a visual presentation via the video output port 248. The reference pictures in compression engine memory 219 may be output or displayed simultaneously with the presentation of a different video program, such as when outputting them as a smaller picture to effect a picture-in-picture (PIP) presentation. For instance, the pictures of the different or second video program may be reconstructed pictures that are decompressed by video decompression engine 223 while decompressing a second compressed video stream. Video decompression engine 223 stores the reconstructed pictures in decompression engine memory 224. The reconstructed pictures produced by compression engine 220, residing in compression engine memory 218, may be presented for spatial resealing by a resizing-capable device in STT 200, such as through a display pipeline (not shown) located between compression engine memory 218 and output system 248, to prepare them as a signal suitable for presentation with the reconstructed pictures of the second video program produced by decompression engine memory 224. For instance, the reconstructed pictures produced by compression engine 220 may be rescaled to be presented in a PIP presentation. A simultaneous presentation of two video programs is effected by providing the respective reconstructed pictures via output system 248 (also referred to as a video output port).

In one embodiment, an extra portion of memory corresponding to an amount equal to a framestore is designated in compression engine memory 218 to enable a delay of one picture output time (e.g., one picture output interval) that facilitates the simultaneous presentation of reconstructed pictures stemming from the two different video programs (e.g., including a PIP presentation). The presentation includes reconstructed pictures produced by video decompression engine 223 simultaneously with reconstructed pictures produced by compression engine 220 on a real-time basis. The picture output time delay allows the reconstructed pictures from compression engine memory 218 to be output according to a clock that drives or generates the video output signal of output system 248, which is typically independent, and thus different, from the clock of the input video signal input to compression engine 220 (e.g., the digitized pictures). As a non-limiting example, the clock generating the video output signal of output system 248 may correspond to, or be derived from, the clock of the second video program. The two clocks are different because they may represent two different video signals, or because they are not locked in phase even when they correspond to the same type of video signal. For instance, in processing two types of video signals, a clock may correspond to an SD video signal while the other clock may correspond to an HD video signal. Two independent clocks corresponding to the same type of video signal may, and do not typically, run locked-in phase. The “one picture output interval” delay enables the clock of the video stream provided by compression engine 220 to be frequency-locked to the video clock of output system 248.

In another embodiment, unlike a typical decoder emulator operation that only decodes and reconstructs reference pictures, decoder emulator 219 also reconstructs non-reference pictures (e.g., B pictures in MPEG-2) in compression engine memory 218. The video stream produced by compression engine 220 includes both reference and non-reference pictures, and compression engine 220 produces reconstructed pictures in compression engine memory 218 corresponding to the respective reference and non-reference pictures.

In one embodiment, a picture output (or picture display) process outputs reconstructed reference pictures from the compression engine memory 218 rather than reconstructed pictures produced by the video decompression engine 222 to provide a visual presentation of a video program being received by STT 200. The reconstructed pictures in compression engine memory 218 are output in real-time while the compression engine 220 simultaneously compresses a sequence of digitized uncompressed pictures corresponding to the received video program. This process avoids delays that would otherwise be attributed to an overall process that would perform the following steps: (1) storing the compressed video pictures to persistent storage device 263 (e.g., hard disk drive), (2) transferring the compressed video stream thereafter from the storage device 263 to decompression engine memory 224, (3) providing the compressed pictures to the video decompression engine 223 from decompression engine memory 224, (4) the decompression engine 222 decompressing and reconstructing the pictures into decompression engine memory 224, and (5) outputting the reconstructed pictures from decompression engine memory 224 via an output system 248.

In conventional systems, the digitized pictures of a video program presented as input to the compression engine 220 can be output simultaneously via an output system 248 to avoid delay of its presentation in non-time-shifted operations. However, there may be disparity in the video quality of the two presentation versions of the video program, namely the version corresponding prior to compression and the reconstructed version corresponding to decompression of the compressed video stream. The latter may be provided during a time-shift operation. Thus, the various embodiments of video processing systems described herein perform time-shifted video operations while maintaining consistent video quality, and while minimizing delay. That is, during a real-time video presentation, the reconstructed pictures are retrieved from compression engine memory 218 and output to a video output port 248, where the pictures of a first video program are scaled or formatted for video presentation on a television set or other display device 140.

By outputting the reconstructed pictures from compression engine memory 218, the video decompression engine 223 that ordinarily performs video decompression in a time-shifted video operation becomes free to perform other operations, such as a real-time transcode operation (e.g., conversion from one video coding format to another), or real-time decompression of the second video program that can be simultaneously presented with the first video program, e.g., as a PIP. The display of the reconstructed pictures from compression engine memory 218 also circumvents having to access the storage device 263 on a real-time basis.

In one embodiment, while compression engine 220 is producing a first video stream that is being output to storage device 263, subsequent to a pause command (e.g., such as one instigated by a viewer), segments comprising a plurality of compressed pictures of a video stream are retrieved from storage device 263 and decompressed and reconstructed by video decompression engine 223 to enable time-shifted presentations. These reconstructed pictures are then formatted and output in known manner through the video output port 248 and then presented on the display device 140.

In one embodiment, the compression engine 220 also stores the digitized pictures (or copies thereof) in compression engine memory 218 prior to compression for use in performing motion estimation. The decoder emulator 219 of the compression engine 220 also reconstructs reference and/or non-reference pictures from the compressed picture sequences, and stores the same in compression engine memory 218 for use in motion compensation and/or for presentation to the video output port 248 for subsequent display, as described below. The pictures compressed by the compression engine 220 are also provided as a compressed video stream to the storage device 263 even though real-time display operations are implemented via the reconstructed pictures stored in the compression engine memory 218. Compression engine 220 performs compression of pictures in accordance with the syntax and semantic of a video coding specification.

In one embodiment, the compression engine 220 cooperates with video decompression engine 223 for enabling decompression engine 223 to reconstruct the non-reference pictures that compression engine 220 does not reconstruct. Compression engine 220 stores the compressed non-reference pictures that it does not reconstruct in the output video stream buffer (not shown) in compression engine memory 218 and provides indices or pointers to the location of the non-reconstructed pictures in the output video stream. With the assistance of the provided indices and pointers, the non-reconstructed pictures in the output video stream buffer are identified by video decompression engine 223. Video decompression engine 223 decompresses and reconstructs the non-reference pictures, using reconstructed pictures in compression engine memory 218 for motion compensation. The reconstructed non-reference pictures are then output during their corresponding display output interval via output system 248. In one embodiment, video decompression engine 223 stores in compression engine memory 218 the reconstructed pictures it produces, which correspond to the non-reference pictures in the video stream produced by compression engine 220. In another embodiment, video decompression engine 223 stores them in decompression engine memory 224. In yet another embodiment, video decompression engine 223 decompresses and reconstructs pictures from the output video stream buffer during occasions when compression engine 220 does not have resources or capability to reconstruct non-reference pictures.

Each video stream provided by compression engine 220 may be compressed in one of a plurality of compression formats and in accordance to a video coding specification that is compatible with the capabilities of compression engine 220. Furthermore, each compressed video stream may comprise a sequence of data packets containing a header and a payload. Each header may include a unique packet identification code (PID) associated with the respective compressed stream.

In one embodiment, each segment of compressed pictures may be retrieved and converted from a first video compression format to a second video compression format (i.e., a transcode operation) via the video decompression engine 223 in cooperation with the compression engine 220. For example, conversion or transcoding is performed segment by segment, on a non-real time basis (or real-time basis in some implementations) by accessing one segment of a first compressed video stream at a time from storage device 263. The speed of a transcoding operation is determined by the amount of available resources in the STT 200 (e.g., memory, memory bus bandwidth, and compression engine processing).

In one embodiment, a real-time transcode operation from a first to a second video stream is performed while simultaneously outputting reconstructed pictures produced by compression engine 220. The transcode and presentation of the video is effected while simultaneously performing the following operations: (1) the first video stream is received in sequential portions in STT 200; (2) the received portions of the first video stream are deposited sequentially in decompression engine memory 224; (3) the video decompression engine 223 accesses the portions of the first video stream from decompression engine memory 224 and decompresses and reconstructs pictures of the first video stream; (4) compression engine 220 receives the reconstructed pictures of the first video stream as a sequence of digitized uncompressed pictures; (5) compression engine 220 compresses the received sequence of digitized uncompressed pictures, producing them as compressed pictures of the second video stream and storing them in compression engine memory 218; (6) decoder emulator 219 reconstructs the compressed pictures of the second video stream, storing the reconstructed pictures of the second video stream in compression engine memory 218; (7) the second video stream is stored in persistent storage device 263 by transferring sequential portions of the second video stream from compression engine memory 218; and (8) the reconstructed pictures of the second video stream produced by the decoder emulator (that reside temporarily in compression engine memory 218) are output to a television set or other display device 140 via output system 248.

In the transcode operation, the first video stream is received as pictures compressed in accordance with the syntax and semantics of a first video compression specification (e.g., MPEG-2 video) via communication interface 242 or communication port 264. The compressed pictures in the second video stream produced by compression engine 220 are in accordance to the syntax and semantics of a second video compression specification, such as ITU H.264. Video decompression engine 223 decompresses the compressed pictures in the first video stream in their transmission order (i.e., in the order received). Compression engine 220 compresses the reconstructed pictures produced by video decompression engine 223 and produces sequential portions of the second video stream, each portion containing at least one compressed picture.

In one embodiment of the real-time transcode operation, video decompression engine 223 receives a portion of the first video stream while it simultaneously decompresses and reconstructs one or more pictures of the immediately prior portion of the first video stream. Video decompression engine 223 decompresses and reconstructs a portion of the first video stream while compression engine 220 simultaneously, or substantially concurrently, compresses one or more of the reconstructed pictures of the immediately prior portion of the first video stream, which results in the compressed pictures of a portion of the second video stream. Compression engine 220 compresses a portion of the second stream, which correspond to a particular portion of the first video stream, while its decoder emulator 219 simultaneously, or substantially concurrently, decompresses and reconstructs one or more pictures corresponding to the immediately prior portion of the second video stream, which correspond to the portion of the first video stream immediately prior to the particular portion. The decoder emulator 219 decompresses and reconstructs a portion of the second video stream while simultaneously, or substantially concurrently, one or more pictures corresponding to the immediately prior portion of the second video stream is output to a television or other display device via output system 248.

As a non-limiting example of the orchestration of the simultaneous operations, a fourth portion of the first video stream is received into a memory (e.g., decompression engine memory 224 or memory 249) immediately after a third portion, which in turn is received immediately after a second portion, which in turn is received after a first portion. Video decompression engine 222 decompresses and reconstructs one or more pictures of the fourth portion of the first video stream while compression engine 220 simultaneously compresses one or more reconstructed pictures of the third portion of the first video stream, producing them as compressed pictures in a third portion of the second video stream. While compression engine 220 is producing the third portion of the second video stream, decoder emulator 219 simultaneously decompresses and reconstructs one or more pictures of a second portion of the second video stream, which correspond to the second portion of the first video stream. The reconstructed pictures produced by decoder emulator 219 are stored in compression engine memory 218. While the decoder emulator 219 is decompressing and reconstructing the second portion of the second video stream, one or more pictures of a first portion of the second video stream residing in compression engine memory 218, which correspond to the first portion of the first video stream, are output simultaneously via output system 248.

In an alternate embodiment, the first and second video streams are compressed in accordance with the syntax and semantics of the same video compression specification but transcoding of the first video stream into the second video stream effects a change in one or more characteristics or parameters of the video. As a non-limiting example, the transcode operation may result in one or more of the following changes: picture resolution, picture rate, and/or picture quality. A transcode operation may include, for example, a conversion from a first to a second picture format, such as from a high definition format (HD) to a standard definition format (SD). A transcode operation from a first to a second picture format may or may not include a conversion from a first to a second and different video coding specification.

In one embodiment, a plurality of tuners and respective demodulating systems 213, demultiplexing systems 215, and signal processing systems 214 may simultaneously receive and process a plurality of respective broadcast digital video streams. Alternatively, a single demodulating system 213, a single demultiplexing system 215, and a single signal processing system 214, each with sufficient processing capabilities may be used to process a plurality of digital video streams.

In yet another embodiment, a first tuner in tuning system 245 receives an analog video signal corresponding to a first video channel and a second tuner simultaneously receives a digital compressed stream corresponding to a second video channel. The video signal of the first video channel is converted into a digital format. The second video stream and/or a compressed digital version of the first video stream may be stored in the storage device 263. Data annotations for each of the two streams may be performed to facilitate future retrieval of the video streams from the storage device 263. The first video stream and/or the second video stream (and/or the corresponding data annotations) may also be routed to the decompression engine 222 for decompression, reconstruction, and subsequent presentation via the television set 140 (FIG. 1).

A plurality of compression engines 220 may be used to simultaneously compress a plurality of digitized video signals (i.e., resulting from analog video signals or decompressed and reconstructed pictures from first video streams, or a combination of both). Alternatively, a single compression engine 220 with sufficient processing capabilities may be used to compress a plurality the video corresponding to respective video programs. Compressed digital versions of respective video programs, or respective second video programs, may be stored in persistent storage, such as the storage device 263. Data annotations for each generated compressed video stream may be performed to facilitate future retrieval of the video streams from storage device 263 or for performing a transcoding operation.

The STT 200 includes at least one persistent storage device, such as storage device 263, for storing video streams received by the STT 200. The storage device 263 may be any type of electronic storage device including, for example, a magnetic, optical, or semiconductor based storage device. The storage device 263 preferably includes at least one hard disk 201 and a controller 269. A digital video recorder (DVR) application 267, in cooperation with a device driver 211, effects, among other functions, read and/or write operations to the storage device 263. The controller 269 receives operating instructions from the device driver 211 and implements those instructions to cause read and/or write operations to the hard disk 201. Herein, references to read and/or write operations to the storage device 263 will be understood to refer to operations to the medium or media (e.g., hard disk 201) of the storage device 263 unless indicated otherwise.

The storage device 263 is preferably internal to the STT 200, and coupled to a common bus 205 through an interface (not shown), such as, for example, among others, an integrated drive electronics (IDE) interface that allows internal or external connections. Alternatively, the storage device 263 can be externally connected to the STT 200 via a communication port 264. The communication port 264 may be, for example, a small computer system interface (SCSI), an IEEE-1394 interface, or a universal serial bus (USB), among others. Common bus 205 may comprise more than one distinct bus connecting different sets of the subcomponents in STT 200.

The device driver 211 is a software module preferably resident in the operating system 253. The device driver 211, under management of the operating system 253, communicates with the storage device controller 269 to provide the operating instructions for the storage device 263. As device drivers and device controllers are known to those of ordinary skill in the art, further discussion of the detailed working of each will not be described further here.

In one embodiment, information pertaining to the characteristics of a recorded video stream is contained in program information file 203 and is interpreted to fulfill the specified playback mode in the request. The program information file 203 may include, for example, the packet identification codes (PIDs) corresponding to the recorded video stream. The requested playback mode is implemented by the processor 244 based on the characteristics of the compressed data and the playback mode specified in the request. Video and/or audio streams that are to be retrieved from the storage device 263 for playback may be deposited in an output cache corresponding to the storage device 263, transferred to memory 249, and then transferred to the decompression engine memory 224, from where they may be retrieved and processed for playback by the decompression engine 222.

In one embodiment, the operating system (OS) 253, device driver 211, and controller 269 cooperate to create a file allocation table (FAT) 204 comprising information about hard disk clusters and the files that are stored on those clusters. The OS 253 can determine where data corresponding to a file is located by examining the FAT 204. The FAT 204 also keeps track of which clusters are free or open, and thus available for use.

The DVR application 267 provides a user interface that can be used to select a desired video presentation currently stored in the storage device 263. The DVR application 267 may also be used to help implement requests for trick mode operations in connection with a requested video presentation, and to provide a user with visual feedback indicating a current status of a trick mode operation (e.g., the type and speed of the trick mode operation and/or the current picture location relative to the beginning and/or end of the video presentation).

When an application such as the DVR application 267 creates (or extends) a video stream file, the operating system 253, in cooperation with the device driver 211, queries the FAT 204 for an available cluster for writing the video stream. As a non-limiting example, to buffer a downloaded video stream into the storage device 263, the DVR application 267 creates a video stream file and file name for the video stream to be downloaded. The DVR application 267 causes a downloaded video stream to be written to the available cluster under a particular video stream file name. The FAT 204 is then updated to include the new video stream file name as well as information identifying the cluster to which the downloaded video stream was written.

If additional clusters are needed for storing a video stream, then the operating system 253 can query the FAT 204 for the location of another available cluster to continue writing the video stream to the hard disk 201. Upon finding another cluster, the FAT 204 is updated to keep track of which clusters are linked to store a particular video stream under the given video stream file name. The clusters corresponding to a particular video stream file may be contiguous or fragmented. A defragmentor, for example, can be employed to cause the clusters associated with a particular video stream file to become contiguous.

Although shown as separate components in FIG. 2, it should be appreciated by one having ordinary skill in the art in the context of the present disclosure that the video decoding (decompression) functionality of the video decompression engine 223 and the compression and decoding emulation functionality of the compression engine 220 can be configured in some embodiments on a single chip (e.g., as an applications specific integrated circuit, or ASIC, core processing unit, among other types of devices).

One preferred embodiment of a video processing system 300 represented by the flow diagram shown in FIG. 3, includes the compression engine 220 and the compression engine memory 218 that cooperate to provide compression of digitized video pictures and reconstruction of the compressed pictures for eventual presentation (e.g., display) by a display device, such as a television set 140 (FIG. 1). The video processing system 300 can also include additional components as illustrated in FIG. 3, including components not shown (e.g., processor 244, FIG. 2). FIG. 3 thus illustrates one embodiment of the video processing system 300, and in particular, shows the video processing flow from the receipt of a sequence of digitized pictures of a video signal to presentation by a television set 140. The sequence of digitized pictures of the video signal may be provided by analog video decoder 216 when it receives pictures sequences, for example from a transmission channel (302) carrying a video program as an analog video signal, and digitizes the pictures. The analog video decoder 216 provides the digitized uncompressed pictures (304) to the compression engine 220. These digitized pictures may be in raw or digitized YCbCr format, among other pixel specification formats. The compression engine 220 stores copies of the digitized pictures in compression engine memory 218 (306). The digitized pictures are compressed by compression engine 220 as non-reference or reference pictures, such as intra-coded (I) pictures which are typically reference pictures in MPEG-2 video, for use in motion estimation. Reference pictures can also include P pictures of MPEG-2 video. The compression engine 220 is configured to compress the digitized pictures according to the syntax and semantics of a video coding specification, such as a standard like MPEG-2 video, ITU H.264, etc.

In an alternate embodiment, video processing system 300 represented by the flow diagram shown in FIG. 3, is started by providing the digitized uncompressed pictures (304) to the compression engine 220 from a decompression engine memory 224.

The compression engine 220 (or rather, the decoder emulator 219 of the compression engine 220 as is to be understood throughout this disclosure) decompresses the compressed pictures and stores copies of the resultant reconstructed pictures in the designated section of compression engine memory 218 (307) organized as one or more framestores (not shown). From the compression engine memory 218, the reconstructed pictures, which in one embodiment includes reference and non-reference pictures, are provided to the video output port 248 for eventual display.

The compression engine 220 provides the compressed pictures as a compressed video stream, or packetized compressed video stream, to the storage device 263 (308), and the compression engine memory 218 provides the reconstructed reference pictures to the video output port 248 (310), thus circumventing the need to access the storage device 263 for real-time display processing. In an alternate embodiment, non-reference pictures are decompressed and reconstructed by decompression emulator 219 and also output. The video output port 248 or a display pipeline (not shown) as described above, or both working in concert, formats the reconstructed pictures to a format suitable for the television set 140, such as NTSC, and provides the formatted pictures to the television set 140 (312).

By storing the reconstructed pictures in the compression engine memory 218, the video decompression engine 223 can be freed from real-time decompression operations for purposes of processing the video of another video program or enabled to perform other functions (e.g., decode the first video stream in transcode operations). Further, by saving the reconstructed pictures in compression engine memory 218, there is a savings in memory consumption and bus bandwidth since conventional display processing typically requires decoder memory and compression engine memory to perform what is now being performed out of compression engine memory 218. Also, the quality of the displayed pictures is preserved between real-time and time-shifted presentations since in both modes of display processing of a time-shifted or recorded video program, the pictures are reconstructed from similarly compressed pictures.

FIG. 4 illustrates another embodiment of a video processing system 400, and in particular, shows the video processing flow from the receipt of a sequence of digitized uncompressed pictures of a video signal to presentation by a television set 140. Similar to the video processing described above in 302-306 (FIG. 3), the digitized uncompressed pictures of the video signal may be provided by video decoder 216 after it receives an analog video signal (402), digitizes the pictures, and then provides the digitized pictures to the compression engine 220 (404). The compression engine 220 stores copies of the digitized pictures in compression engine memory 218 (406). The compression engine 220 is also configured to compress the digitized pictures according to the syntax and semantics of a video coding specification such as a standard like MPEG-2 video, ITU H.264, etc.

In an alternate embodiment, video processing system 400 represented by the flow diagram shown in FIG. 4, is started by providing the digitized uncompressed pictures (404) to the compression engine 220 from a decompression engine memory 224.

The decompression emulator 219 in compression engine 220 decompresses the compressed pictures and stores the resultant reconstructed pictures in framestores in compression engine memory 218 (407). The reconstructed pictures in this embodiment include reference pictures, whereas the video decompression engine 223 is used to reconstruct the compressed non-reference pictures, as explained below and above. The compression engine 220 also stores copies of the compressed pictures it does not reconstruct in a output video stream buffer in compression engine memory 218 (408), and further provides the compressed pictures (or copies thereof) to the storage device 263 (410).

The video decompression engine 223 accesses the compression engine memory 218 to reconstruct compressed non-reference pictures (e.g., B pictures in MPEG-2 video) and then stores the reconstructed pictures in the compression engine memory 218 (412). The compression engine memory 218 provides the reconstructed pictures (reconstructed non-reference pictures provided by the video decompression engine 223 and/or reference pictures reconstructed by the compression engine 220) to the video output port 248 (414), thus again circumventing the need to access the storage device 263 for real-time display processing. The video output port 248 formats the reconstructed pictures and provides the formatted pictures to the television set 140 (416).

Resources are conserved in this embodiment in that reconstruction and display processing is provided through the use of a unified memory (i.e., compression engine memory 218), bus bandwidth is reduced, and storage device access is reduced. Further, quality is preserved consistently between a real-time video presentation and a time-shifted presentation of a video program.

Note that although the embodiments described in association with FIGS. 4 and 5 are described in the context of an analog video signal received through the analog video decoder 216, it should be understood in the context of this disclosure that similar principles commencing beyond the analog video decoder 216 (e.g., commencing at 304 or 404) apply when video signals are received by video decompression engine 223 as a first compressed video stream, decompressed and reconstructed into a sequence of digitized uncompressed pictures that are then provided to compression engine 220. Alternatively, the sequence of digitized uncompressed pictures may be provided to compression engine 220 from other components or sources in, or connected to, STT 200.

FIG. 5 is a functional flow diagram that illustrates one embodiment for the video decompression operation 412a (an embodiment of the operation 412 shown in FIG. 4) corresponding to access to an output video stream buffer 218a of the compression engine memory 218. Flow of operation is represented using labeled arrows 502-508. In particular, the video decompression engine 223 accesses and parses the output video stream buffer 218a of compression engine memory 218 in search of pictures that the compression engine 220 is not configured in a particular implementation to reconstruct, such as compressed non-reference pictures (e.g., labeled as cNonRefpicture_{1,1} and cNonRefpicture_{1,2}, etc. in FIG. 5) (502). With the assistance of auxiliary information produced by compression engine 220 to assist video decompression engine 223 in locating the compressed non-reference pictures in output video stream buffer 218a, the video decompression engine 223 uses the auxiliary information to identify compressed non-reference pictures and copies the same (e.g., cNonRefpicture_{1,1} and cNonRefpicture_{1,2}, etc.) from a first portion 510 of the output video stream buffer 218a to a second section of memory 512 (504). The video decompression engine 223 then retrieves the copied pictures (506), performs decompression and reconstruction with the assistance of reconstructed reference pictures produced by compression engine 220 that reside in compression memory 218, and stores the reconstructed non-reference pictures in a display buffer 218c (otherwise known as framestores as described above) of the compression engine memory 218 (508). The reconstructed pictures are then provided to the video output port 248 (FIG. 2) in a manner as described above. Video decompression engine 223 performs decompression of non-reference pictures in cooperation with compression engine 220 by using the reconstructed reference pictures in compression engine memory 218, as required during temporal or motion compensated operations during the decompression of a non-reference picture.

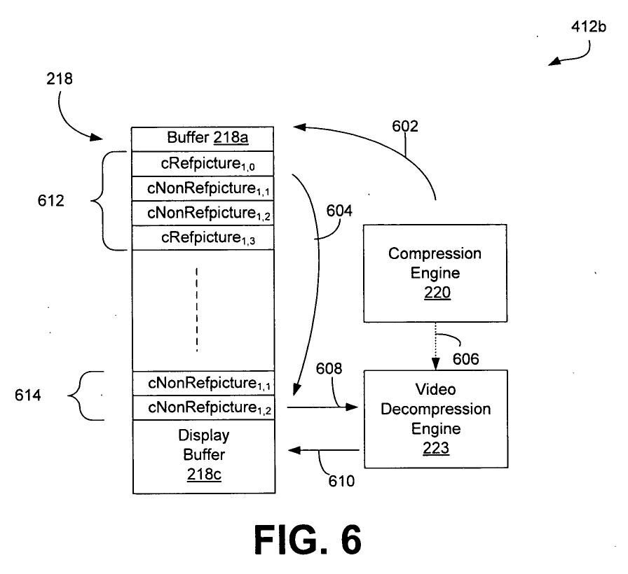

FIG. 6 is a functional flow diagram that illustrates one embodiment for the video decompression operation 412b (an embodiment of 412 in FIG. 4) corresponding to access to the output video stream buffer 218a of the compression engine memory 218. In particular, the compression engine 220 accesses and parses the output video stream buffer 218a of compression engine memory 218 in search of pictures that it will not reconstruct, such as compressed non-reference pictures (602). The compression engine 220 then copies the identified compressed, non-reference pictures (e.g., cNonRefpicture_{1,1} and cNonRefpicture_{1,2}, etc.) from a first portion 612 of the output video stream buffer 218a to a second portion of memory 614 (604). The copy operation can occur at any time during the real-time video processing of the received pictures. The compression engine 220 then alerts the video decompression engine 223 that it has performed a copy operation of the of the compressed non-reference pictures 218a (606). The video decompression engine 223 then accesses the copied portion of the output video stream buffer 218a (608) to retrieve the compressed pictures and performs reconstruction of the same, and then stores the reconstructed non-reference pictures in a display buffer or framestore 218c of the compression engine memory 218 (610). The reconstructed pictures are then provided to the video output port 248 (FIG. 2) in a manner as described above.

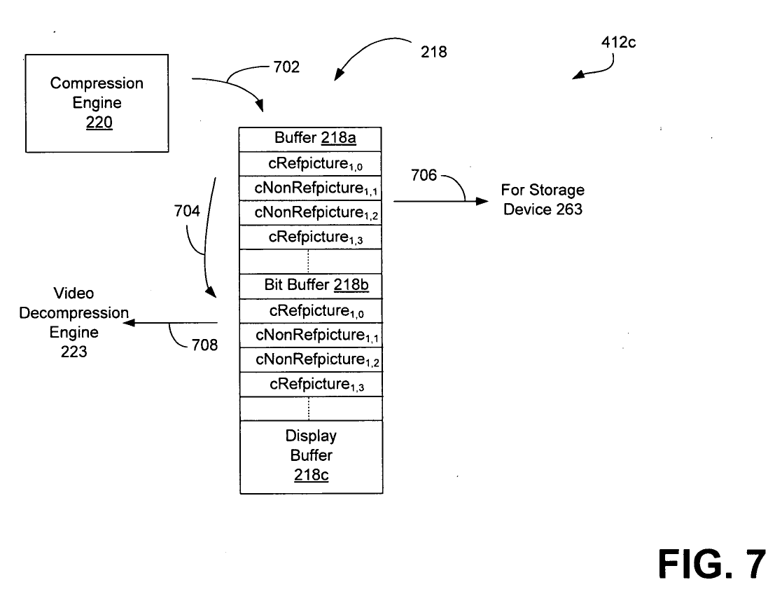

FIG. 7 is a functional flow diagram that illustrates one embodiment for the video decompression operation 412c (an embodiment of 412 in FIG. 4) corresponding to access to the output video stream buffer 218a of the compression engine memory 218. In particular, the compression engine 220 accesses the output video stream buffer 218a of the compression engine memory 218 (702). The compression engine 220 then copies the entire buffer 218a, providing a copy (output video stream buffer 218b) in another section of the compression engine memory 218 (704). Thus, the output video stream buffer 218a can be used to provide pictures to the storage device 263 (706), and the output video stream buffer 218b can be used in coordination with the video decompression engine 223 (FIG. 2) in the manner described in the flow diagrams of FIGS. 5 and 6 (708). This copying of the output video stream buffer 218a enables the video decompression engine 223 to more precisely follow the timing and synchronization of the compression engine 220.

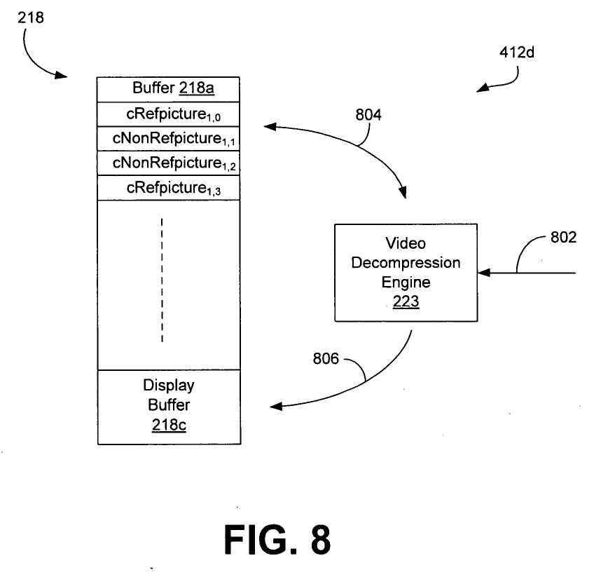

FIG. 8 is a schematic diagram that illustrates one embodiment for the video decompression operation 412d (an embodiment of 412 in FIG. 4) corresponding to access to the output video stream buffer 218a of the compression engine memory 218. In particular, the video decompression engine 223, alone or in combination with the processor 244 (FIG. 2), receives auxiliary or meta data corresponding to compressed video streams (compressed by the compression engine 220) (802). The auxiliary data or meta data provides the locations (e.g., register addresses) of the pictures that the compression engine 220 will not reconstruct, thus enabling the video decompression engine 223 to access the output video stream buffer 218a without parsing through every picture of the output video stream buffer (804). The video decompression engine 223 then reconstructs the compressed pictures it retrieves from the output video stream buffer 218a and stores the reconstructed pictures in the display buffer 218c of the compression engine memory 218 (806). From the compression engine memory 218, the pictures can be provided to the video output port 248 (FIG. 2) and then subsequently to the television set 140 (FIG. 1).

Note that in some embodiments, the video decompression engine 223 can operate out of framestores and/or output video stream buffers provided in decompression engine memory 224, while still retaining the benefit of circumventing access to the storage device 263.

The functionality provided by the operations or methods illustrated in FIGS. 3-8 can be embodied in any computer-readable medium for use by or in connection with a computer-related system (e.g., an embedded system) or method. In this context of this document, a computer-readable medium is an electronic, magnetic, optical, semiconductor, or other physical device or means that can contain or store a computer program or data for use by or in connection with a computer-related system or method. Furthermore, the functionality provided by the methods illustrated in FIGS. 3-8 can be implemented through hardware (e.g., an application specific integrated circuit (ASIC) and supporting circuitry), software, or a combination of software and hardware.

It should be emphasized that the above-described embodiments of the disclosure are merely possible examples, among others, of the implementations, setting forth a clear understanding of the disclosed principles. Many variations and modifications may be made to the above-described embodiments without departing substantially from the principles of the disclosure. All such modifications and variations are intended to be included herein within the scope of the disclosure and protected by the following claims. In addition, the scope of the disclosure includes embodying the functionality of the preferred embodiments in logic embodied in hardware and/or software-configured mediums.

At least the following is claimed:

1. A system, comprising:
logic configured to coordinate the output of video program from an encoder or a decoder.

2. The system of claim 1, wherein the logic resides in a digital home communication terminal.
